(19) United States
(12) Patent Application Publication
(10) Pub. No.: US 2007/0196516 A1
(43) Pub. Date: Aug. 23, 2007

(54) Sugar substitute and rapid localized delivery system

(76) Inventor: Scott A.M. Chambers, Bethesda, MD (US)

Correspondence Address: Lacy Kolo, 14591 Golden Oak Road, Centreville, VA, 20121, US

(21) Appl. No.: 11/582,543

(22) Filed: Oct. 18, 2006

Related U.S. Application Data
(60) Provisional application No. 60/727,943, filed on Oct. 18, 2005.

(51) Int. Cl. A23L 1/29; A23L 1/212

(52) U.S. Cl. 424/725; 426/134; 426/531; 426/615

(57) ABSTRACT

A film composition for orally delivering a variety of substances to a person. In one embodiment, the substance is a reduced calorie sugar substitute derived from species of the plant genus Synsepalum. The reduced calorie substitute can be utilized to control calorie intake or to make the delivery of drugs, pharmaceuticals or cosmetics more palatable. In other embodiments, the substance is a drug product or medicant. Further, the film compositions can be used to deliver a wide variety of substances directly to the taste buds, thereby increasing the localized concentration of the substances. Also provided a generally applicable orally consumable sugar substitute.

### BACKGROUND OF THE INVENTION

1. Field of the Invention

This invention relates to a film for delivering substances to a person. In one preferred embodiment, the substance is a reduced calorie sugar substitute derived from species of the plant genus Synsepalum. Also provided is a generally applicable orally consumable sugar substitute. The reduced calorie substitute can be utilized to control calorie intake or to make the delivery of drugs, pharmaceuticals or cosmetics more palatable. This application claims priority to U.S. Ser. No. 60/727,943 filed Oct. 18, 2005, which is incorporated in its entirety by reference.

2. The Prior Art

The use of consumable films for the oral delivery of breath freshening agents has become increasingly popular. It is known to the prior art to use consumable films adapted to dissolve in the oral cavity containing flavoring agents for delivering breath freshening agents. For example, WO 00/18365 discloses a breath freshening film adapted to dissolve in the mouth of a consumer comprised of a water soluble polymer such as pullulon or hydroxypropylmethyl cellulose and an essential oil selected from thymol, methyl salicylate, eucalyptol and menthol.

U.S. Pat. No. 4,713,243 discloses a bioadhesive film for delivering therapeutic agents to the oral cavity which is capable of adhering to a wet mucosa surface, composed of a water soluble polymer matrix of 40-95% by weight of a hydroxypropyl cellulose having a molecular weight of about 100,000, 5-60% of a homopolymer of ethylene oxide having a molecular weight from 3,000,000 to 5,000,000, 0-10% of a water-insoluble polymer selected from ethyl cellulose, propyl cellulose, polyethylene and polypropylene, and 10% of a plasticizer, the film having incorporated therein a pharmaceutically effective amount of medicament for the treatment of periodontal disease. The film is flexible when wet so as to be unobtrusive to the user after it has been properly positioned and placed in the mouth.

U.S. Pat. No. 5,354,551 discloses a water soluble film presegmented into dosage units, the film containing conventional toothpaste ingredients and formulated with swellable polymers such as gelatin and corn starch as film forming agents which upon application to the oral cavity slowly disintegrate, thereby releasing an active agent incorporated in the film.

U.S. Pat. No. 6,177,096 discloses a film composition containing therapeutic and/or breath freshening agents for use in the oral cavity prepared from a water-soluble polymer such as hydroxypropylmethyl cellulose, hydroxypropylcellulose and a polyalcohol such as glycerol, polyethylene glycol. When applied to the oral cavity, the film exhibits instant wettability followed by rapid dissolution.

U.S. Pat. No. 6,419,903 discloses a film composition containing breath freshening agents for use in the oral cavity prepared from a homogeneous mixture of a water soluble, low viscosity hydroxyalkylmethyl cellulose, a water dispersible starch and a flavoring agent.

Films may also be used to rapidly deliver drugs to a patient orally. As the film dissolves, the orally delivered drug product readily passes across oral membranes, thus absorption is very high. Such high absorption is not the normal expectation for oral drugs that are ingested. Before reaching the vena cava, the drug must move down the alimentary canal and pass through the gut wall and liver, which are common sites of drug metabolism. Thus, the drug may be metabolized before it can be absorbed in the body and measured in the general circulation. This causes a decrease in drug input is referred to as the first pass effect. A large number of drugs show low bioavailability owning to an extensive first pass metabolism. The two other most frequent causes of low bioavailability are insufficient time in the GI tract and the presence of competing reactions. See, e.g., Merck Manual at page 2602.

Bioavailability considerations are most often encountered for orally administered drugs. Differences in bioavailability can have profound clinical significance.

Although parenteral administration does provide a method for eliminating a number of the variables that are present with oral administration, parenteral administration is not a preferable route. Typically parenteral administration requires the use of medical personnel and is just not warranted nor practical for the administration of most agents and drugs, e.g., analgesics. Even when required, parenteral administration is not preferred due to patient concerns including comfort, infection, etc., as well as the equipment and costs involved.

Further, use of an oral dissolvable film is highly desirable to deliver drugs and other substances to a person as the substances can be applied in a predetermined pattern. The substance may therefore be applied to the film in small, high concentrated areas. Applicants believe the benefit of using such a pattern is that the high concentration of substance in the concentrated areas “forces” the substance through the membrane by diffusion. This therefore helps large substances which ordinarily have difficulty passing the membrane, such as large proteins, cross the membrane barrier.

### SUMMARY OF THE INVENTION

In accordance with some embodiments of the present invention there is provided methods and compositions for delivering an artificial sweetener/sugar substitute derived from plants of the genus Synsepalum. Upon administration of the film of the present invention, there is provided a locally applied and easily metered amount of the pulp or an extract of that pulp. The amount of extract applied can be varied to suit the desired sweetness. In one embodiment, the artificial sweetener is applied in a rapidly dissolvable, orally consumable film. The application can be metered by varying the amount used/applied increased concentration of Synsepalum pulp or extract in the films, or increased amounts or spots of Synsepalum pulp or extract on the films.

In yet another embodiment, the sweetener is applied to a swab or strip that is used to apply the material to the tongue without having to be dissolved or dissolvable. These materials can also be used as taste or bitterness modifying compositions for foods, pharmaceuticals, and cosmetics. Other compositions can be used in the film to affect the localized concentration of a wide variety of substances.

In yet another embodiment, the sweetener can be delivered orally as a powdered, solid or liquid substance. Upon administration of the compositions of the present invention, there is provided an amount of the extract and/or component of the extract. The amount of the composition used can be varied to suit the desired sweetness. The application can be metered by varying the amount used/applied, increased concentration of Synsepalum pulp or extract in the films, or increased amounts or spots of Synsepalum pulp or extract on the films.

In yet another embodiment, the sweetener can be delivered orally as a component of a food or drink. Upon administration of the compositions of the present invention, there is provided an amount of the extract and or component of the extract (prepared by extraction of said component from the fruit of Synsepalum, recombinant methods, chemical synthesis, or other standard means of preparation). The amount of the composition used can be varied to suit the desired sweetness.

In yet another embodiment, there is provided methods and compositions for delivering a medicant/drug. Upon administration of the film of the present invention, there is provided a locally applied and easily metered amount of the medicant/drug. The amount of extract applied can be varied to suit the desired medicant/drug dose or diffusion properties.

While many preferred embodiment contemplate delivery of medicants and/or drugs to the mucosal membranes of the mouth by using the film, other contemplated embodiments include delivery to any portion of the body or even open wounds and during surgery. Using materials designed to retard delivery, embodiment can also be useful for sustained release and as a substitute for prior art patch medicants, such as those used to delivery nicotine or estrogen.

### BRIEF DESCRIPTION OF FIGURES

FIG. 1 represents one pattern/amount to be applied for low levels of sweeting.

FIG. 2 represents one pattern/amount to be applied for low levels of sweeting.

FIG. 3 represents one pattern/amount to be applied for low levels of sweeting.

### DETAILED DESCRIPTION OF THE PREFERRED EMBODIMENTS

In one preferred embodiment of the present invention, the water soluble orally applied film comprising an extract from the fruit of the plant genus Synsepalum. The preferred embodiment comprises the extract of Synsepalum dulcificum. The film can further comprise, inter alia, water, additional film forming agents, plasticizing agents, flavoring agents, antimalodor agents, surfactants, emulsifying agents, coloring agents, sweeteners and fragrances, and the like.

Synsepalum dulcificum is indigenous to tropical West Africa, where it is often referred to as “miracle fruit.” The plant, which grows in the form of a shrub, yields ripe red berries from December to June, the berries being ellipsoidal in shape and about 0.75 inch long, and composed of a thin layer of pulp surrounding a single large seed. These berries have the unique property of modifying the taste of acidic (sour) foods to make such foods taste sweet after the fruit pulp has been applied to the tongue by either manual application, chewing the fruit, or other means.

One of the inherent problems encountered with the use of the fruit pulp or extracts thereof of the Synsepalum species, is the controlled application of the material. The amount of “sweetness” achieved and/or the duration of its effect is random and non-specific or controllable. Moreover, using pure extract of the fruit in a food or drink can require large amounts of material. The present invention provides for a controlled application/use of the unique properties of the fruit extract for the controlled application and use as a sugar substitute. In one embodiment the fruit pulp or an extract thereof is dispensed within a rapidly dissolving, orally consumable film. One or multiple sheets of the film can then be placed onto the tongue, all at once or one at a time. The pulp or extract can also be added after the film is created, either as a thin layer or as a series of spots or stripes onto the film. The films can also be manufactured and material with the sweetener on or in it removed, such as via hole punches. In another embodiment, the pulp or extract is applied to a swab that can be rubbed across sections of the tongue or applied as a mist. Delivery of the material on a film or swab permits it to be localized to its site of action.

While applicants do not wish to be constrained to any theory of action, it is believed that materials within the extract temporarily bind to individual tastes buds and experience a conformational change when exposed to an acidic environment. We have discovered that by spotting the material onto or in a film, striping the extract onto or into the film, or removing film material, a larger or smaller number of taste buds will be able to reversibly bind to the active ingredients in the strips. With more or fewer taste buds exposed to the binding agent, the sensation of sweetness is more easily metered. Thus, a very small amount of extract will lead to an unexpectedly large amount of sweetness because the extract is placed in direct contact with the taste buds of the tongue. Such contact means that in the localized region of a taste bud, the extract is present in an exceedingly high concentration. In contrast, the same amount of extract in a glass of water will produce a very low relative concentration in contact with the tongue and a correspondingly low sensation of sweetness when exposed to an acidic environment.

Thus, placing the extract onto a film provides unexpectedly high sweetness for a remarkably small amount of extract or pulp. Accordingly, a high sweetness can be obtained from an unexpectedly low caloric intake of extract because of the greater control of delivery to the taste buds of the tongue. Additionally, by applying the extract in accordance with the preferred embodiments of the present invention, the unexpected result is obtained whereby the sweetening sensation does not last an extended period of time and/or does not adversely effect the taste of the substance which is intended to be sweetened.

It is applicant's present understanding that humans detect taste with taste receptor cells. These are clustered in taste buds. Each taste bud has a pore that opens out to the surface of the tongue enabling molecules and ions taken into the mouth to reach the receptor cells inside. There are at least five primary taste sensations: salty, sour, sweet, bitter, and umami. A single taste bud contains 50-100 taste cells representing all five taste sensations. Thus, the classic textbook pictures showing separate taste areas on the tongue are misleading. Each taste cell has receptors on its apical surface. These are transmembrane proteins that bind to the molecules and ions that give rise to the 5 taste sensations. Although a single taste cell may have representatives of several types of receptor, one type may be more active than the others on that cell. No single taste cell contains receptors for both bitter and sweet sensations.

Each taste receptor cell is connected, through a synapse, to a sensory neuron leading back to the brain. A single sensory neuron can be connected, however, to several taste cells in each of several different taste buds. With salty substances (e.g., NaCl), the receptor is an ion channel that allows sodium ions (Na⁺) to enter directly into the cell. This depolarizes it allowing calcium ions (Ca²⁺) to enter and triggering an action potential in the attached sensory neuron. Several types of receptors may be involved in detecting the protons (H⁺) liberated by sour substances (acids). In one type, the protons block potassium channels thus interrupting the normal outflow of K⁺ that creates the resting potential of the cell. The resting potential of the cell is reduced and if this reaches threshold, an action potential is generated in the attached sensory neuron. Sweet substances (like table sugar—sucrose) bind to G-protein-coupled receptors (GPCRs) at the cell surface. Each receptor contains 2 subunits designated T1R2 and T1R3 and is coupled to G proteins. The complex of G proteins has been named gustducin because of its similarity in structure and action to the transducin that plays such an essential role in rod vision. Activation of gustducin triggers a cascade of intracellular reactions: (1) activation of adenylyl cyclase; (2) formation of cyclic AMP (cAMP), and (3) the closing of K⁺ channels that leads to depolarization of the cell. The mechanism is similar to that used by odor receptors.

The hormone leptin inhibits sweet cells by opening their K⁺ channels. This hyperpolarizes the cell making the generation of action potentials more difficult. The binding of substances with a bitter taste, e.g., quinine, phenyl thiocarbamide, also takes place on G-protein-coupled receptors that are coupled to gustducin. In this case, however, cyclic AMP acts to release calcium ions from the endoplasmic reticulum, which triggers the release of neurotransmitter at the synapse to the sensory neuron. Humans have at least two dozen genes (“T2Rs”) encoding different bitter receptors. However, each taste cell responsive to bitter expresses many of these genes. This is in sharp contrast to the system in olfaction where a single odor-detecting cell appears to express only a single type of odor receptor. Despite this, a single taste cell seems to respond to certain bitter-tasting molecules in preference to others.

The sensation of taste—like all sensations—resides in the brain. Transgenic mice that express T2Rs in cells that normally express T1Rs (sweet) respond to bitter substances as though they were sweet. Transgenic mice that express a receptor for a tasteless substance in cells that normally express T2Rs (bitter) are repelled by the tasteless compound. So it is the activation of hard-wired neurons that determines the sensation of taste, not the molecules nor the receptors themselves.

Umami is the response to salts of glutamic acid—like monosodium glutamate (MSG) a flavor enhancer used in many processed foods and in many Asian dishes. Processed meats and cheeses proteins) also contain glutamate. The binding of amino acids, including glutamic acid, takes place on G-protein-coupled receptors that are coupled to heterodimers of protein subunits designated T1R1 and T1R3. Another umami receptor (at least in the rat's tongue) is a modified version of the glutamate receptors found at excitatory synapses in the brain.

By incorporating compounds known to stimulate the taste buds into or onto films and strips, highly localized concentrations of such stimulants can be obtained on the taste buds. Thus, as explained above, the taste buds can be greatly stimulated without ingesting a large amount of stimulant into the body. Accordingly, just as the sweet sensation can be unexpectedly stimulated with a small amount of material on a film or strip, saltiness, sourness, bitterness and unami should be unexpectedly stimulated. Thus, films of salts and derivatives of glutamic acid can be used in the film to enhance flavors. Similarly, sour films and strips can be created that will provide the sour sensation without the concomitant damages to teeth found in other acidic foods.

While the berries of the Synsepalum species can be used to create a pulp, an extract of that pulp can also be easily created and are also contemplated in the methods and compositions of this invention. By extract, this disclosure means any product of a method to purify or partially purify that component of the fruit that creates a sweet sensation in an acidic environment after coating the tongue. Extracts also encompass the chemical synthesis of the sweetener as well as the production of the material by recombinant methods. Throughout this disclosure, the use of pulp can be substituted for extract and vice versa. U.S. Pat. No. 3,995,031 to Henkin et al. and U.S. Pat. No. 5,886,155 to Armah et al. set forth numerous methods of purification and are incorporated by reference in their entirety. Additional methods of extraction, isolation and or preparation will be understood and within the level of skill of those of ordinary skill in the relevant arts and are intended to be encompassed by the present invention.

Although numerous film preparations have been described and can be employed with the present invention, in the preferred embodiment, a low viscosity hydroxyalkylmethyl cellulose, a starch ingredient, and other film forming ingredients are dissolved in a compatible solvent to foal a film forming composition. The hydroxyalkyl cellulose to starch ratio (by weight) may vary from about 1:3 to about 4:1 and preferably about 1:1.5 to about 2.5:1.

The composition is cast on a releasable carrier and dried. The carrier material must have a surface tension which allows the film solution to spread evenly across the intended carrier width without soaking to form a destructive bond between the film and carrier substrates. Examples of suitable carrier materials include glass, stainless steel, Teflon and polyethylene-impregnated paper. Dying of the film may be carried out at high temperature using a drying oven, drying terminal, vacuum drier, or any other suitable drying equipment which does not adversely effect the ingredients of which the film is composed.

The film, once formed, is segmented into strips of the desired size (width and length) by die-cutting, slicing or slitting-and-die-cutting. In accordance with the preferred embodiment, the segmented film has a strip width and length corresponding to about the size of a postage stamp, generally about 12 to about 30 millimeter in width and about 20 to about 50 millimeters in length. The film has a thickness ranging from about 15 to about 80 micrometers, and preferably about 30 to 60 micrometers. Other sizes are encompassed by the present embodiment of the invention and one of ordinary skill can readily adapt the cutting process to achieve strips of the desired size.

The film is shaped and sized to be placed in the oral cavity. The film is flexible and adheres to a surface in the mouth, usually the roof of the mouth or the tongue, and quickly dissolves, generally in less than 30-40 seconds.

The film forming agent used in the films according to the preferred embodiment of the present invention is preferably a low viscosity hydropropylmethyl cellulose polymer (HPMC). It is critical to the present embodiment of the invention that the HPMC have a viscosity in the range of about 1 to about 40 millipascal seconds (mPa·multidot·s) as determined as a 2% by weight aqueous solution of the HPMC at 20.degree C. using a Ubbelohde tube viscometer. Preferably the HPMC has a viscosity of about 3 to about 20 mPa·multidot·s at 20.degree. C. As will hereinafter be demonstrated, it is critical to the practice of the present invention that a low viscosity hydroxyalkylmethyl cellulose be used in the preparation of the film matrix. At viscosities appreciably higher than about 40 mPa·multidot·s, for a given film thickness, the lower the viscosity of a hydroxyalkyl methyl cellulose such as HPMC, the more rapid the dissolution of the film matrix and the administration of the Synsepalum extract.

In the preferred embodiment, the hydroxyalkyl methyl cellulose is incorporated in the film composition in amounts ranging from about 10 to about 60% by weight and preferably about 15 to about 40% by weight. The actual composition of the film is not critical to the present invention and alternative compositions can be employed without altering the present invention.

The HPMC polymer of the preferred embodiment is a hydroxyalkylmethyl cellulose polymer and is available commercially from the Dow Chemical Company under the trade designation Methocel E5 Premium LV. Methocel E5 Premium LV is a USP grade, low viscosity HPMC having 29.1% methoxyl groups and 9% hydroxyproxyl group substitution. It is a white or off-white free-flowing dry powder.

Cold water swellable, physically modified and pregelatinized starches are particularly useful as texture modifier to increase the stiffness of the hydroxyalkyl methyl cellulose polymer films of the present invention, as the film prepared by HPMC alone, at the thicknesses described for the present invention, tends to curl up after it is cast and dried.

Pregelatinized corn starch is available commercially. A preferred starch is available under the trade designation Cerestar Polar Tex-Instant 12640 from the Cerestar Company. This Cerestar starch is a pregelaterized, stabilized and crosslinked waxy maize starch. It is readily dispersible and swellable in cold water. In its dry form, it is a white free flowing powder with an average particle size no greater than 180 micrometers and 85% of the particles are smaller than 75 micrometers.

The Cerestar starch has excellent cold storage and freeze-thaw stability. It has a rapid hydration rate and can reach extremely high viscosity without cooking. It has a smooth and creamy texture similar to cook-up starches. It also has excellent paste clarity and a bland flavor.

The pregelatinized starch is present in the film of the present invention in an amount ranging from about 5 to about 50% by weight and preferably about 10 to about 35% by weight.

The carrier may also comprise any safe and effective additional film components used in the film compositions of the present invention. Such materials include abrasive polishing materials, elastomers, resins, plasticisers, fats, solvents, waxes, emulsifiers, softeners, bulking agents, sweeteners, absorbents, orally active metallic ions, cationic material, fluoride ion sources, additional anticalculus agents, antimicrobial agents, buffers, whitening agents, alkali metal bicarbonate salts, thickening materials, humectants, water, surfactants, titanium dioxide, flavoring agents, xylitol, coloring agents, and mixtures thereof.

The film composition may also comprise an elastomer or elastomer mixture. The elastomers useful in the present composition include styrene-butadiene rubber (SBR) and other elastomeric materials generally known in the art. Illustrative elastomers include SBR, synthetic films or elastomers such as polyisobutylene and isobutylene-isoprene copolymers; natural films or elastomers such as chicle, natural rubber, jelutong, balata, guttapercha, lechi caspi, sorva and mixtures thereof.

The film composition may also comprise a plasticiser in an amount up to about 15%, preferably from about 0.1% to about 3% by weight of the film composition. Suitable plasticisers include glyceryl triacetate, acetylated monoglyceride, glyceryl tributyrate, ethyl laurate, ethyl acetoacetate, diethyl tartrate, ethyl or butyl lactates, diethyl malate, ethyl oleate, castor oil, succinylated monoglycerides or mixtures thereof. Glyceryl triacetate and acetylated monoglyceride are preferred.

The film is particularly advantageous in these embodiments because it will closely conform to the contours of the moist surface it is placed upon. A dry surface can be moistened with a hydrophilic agent or hydrophobic agent to improve this process. This procedure has the unexpected benefit of greatly increasing the localized concentration of the medicant and raising the efficiency of transfer into the body.

The film may also comprise a substance that is traditionally used as a medicament and lends itself to being administered through the oral cavity. Such substances may be vitamins, cancer chemotherapeutics; antimycotics; oral contraceptives, nicotine or nicotine replacement agents, minerals, analgesics, antacids, muscle relaxants, antihistamines, decongestants, anesthetics, antitussives, diuretics, anti-inflammatories, antibiotics, antivirals, psychotherapeutic agents, anti-diabetic agents and cardiovascular agents, bioengineered pharmaceuticals, nutraceuticals and nutritional supplements. Vitamins and co-enzymes that may be delivered using this invention include but are not limited to water or fat soluble vitamins such as thiamin, riboflavin, nicotinic acid, pyridoxine, pantothenic acid, biotin, flavin, choline, inositol and paraminobenzoic acid, carnitine, vitamin C, vitamin D and its analogs, vitamin A and the carotenoids, retinoic acid, vitamin F and vitamin K.

Anesthetics include etomidate, ketamine, propofol, and benodiazapines (e.g., chlordiazepoxide, diazepame, clorezepate, halazepam, flurazepam, quazepam, estazolam, triazolam, alprozolm, midazolam, temazepam, oxazepam, lorazepam), benzocaine, dyclonine, bupivacaine, etidocaine, lidocaine, mepivacaine, promoxine, prilocaine, procaine, proparcaine, ropivacaine, tetracaine. Other useful agents may include amobartital, aprobarbital, butabarbital, butalbital mephobarbital, methohexital, pentobarbital, phenobarbital, secobarbital, thiopental, paral, chloralhydrate, ethchlorvynol, clutethimide, methprylon, ethinamate, and meprobarnate.

Analgesics include opioids and other medicaments such as morphine, mepidine, dentanyl, sufentranil, alfentanil, aspirin, acetaminophen, ibuprofen, indomethacine, naproxen, atrin, isocome, midrin, axotal, firinal, phrenilin, ergot, and ergot derivatives (wigraine, cafergot, ergostat, ergomar, dihydroergotamine), imitrex, and ketoprofen.

Diuretics include but are not limited to acetazolamide, dichlorphenamide, methazolamide, furosemide, bumetanide, ethacrynic acid torseimde, azosemide, muzolimine, piretanide, tripamide, bendroflumethiazide, benzthiazide, chlorothiazide, hydrochorothiazide, hydroflumethiazide, methyclothiazide, polythiazide, trichlormethiazide, indapamide, metolazone, quiniethazone, amiloride, tniamterene, sprion olactone, canrenone, and potassium canrenoate.

Anti-inflammatories include but are not limited to salicylic acid derivatives (e.g. aspirin), indole and indene acetic acids (indometbacin, sulindac and etodalac) heteroaryl acetic acids (tolmetin diclofenac and ketorolac) aryl propionic acid derivatives (ibuprofen, naproxen, ketoprofen, fenopren, oxaprozine), anthranilic acids (mefenamic acid, meclofenamic acid) enolic acids (piroxicam, tenoxicam, phenylbutazone and oxyphenthatrazone).

Psychotherapeutic agents include thorazine, serentil, mellaril, millazinetindal, permitil, prolixin, trilafon, stelazine, suprazine, taractan, navan, clozaril, haldol, halperon, loxitane, moban, orap, risperdal, alprazolam chordiaepoxide, clonezepam, clorezepate, diazepam, halazepam, lorazepam, oxazepam, prazepam, buspirone, elvavil, anafranil, adapin, sinequan, tofranil, surmontil, asendin, norpramin, pertofrane, ludiomil, pamelor, vivactil, prozac, luvox, paxil, zoloft, effexor, wellbutrin, serzone, desyrel, nardil, parnate, eldepryl.

Cardiovascular agents include but are not limited to nitroglycerin, isosorbide dinitrate, sodium nitroprisside, captopril, enalaprill, enalaprilat, quinapril, lisinopril, ramipril, losartan, amrinone, linnone, vesnerinone, hydralazine, nicorandil, prozasin, doxazosin, bunazosin, tamutosin, yohimbine, propanolol, metoprolol, nadolol, atenolol, timolol, esmolol, pindolol, acebutolol, labetalol, phentolamine, carvedilol, bucindolol, verapamil, nifedipine, amlodipine and dobutamine, or a sexual dysfunction agent like sildenafil citrate (Viagra).

It is envisioned that depending on the substance or medicament, the resultant film can be used to treat inter alia: coughs, colds, motion sickness; allergies; fevers; pain; inflammation; sore throats; cold sores; migraines; sinus problems; diarrhea; diabetes, gastritis; depression; anxiety, hypertension; angina and other maladies and symptoms. Also these films may be useful in ameliorating cravings in substance abuse withdrawal or for appetite suppression. Specific active agents or medicaments include by way of example and limitation: caffeine, aspirin, acetaminophen; ibuprofen; ketoprofen; cimetidine, ranitidine, famotidine, dramamine, omeprazole, dyclonine hydrochloride, chlorpheniramine maleate, pseudoephedrine hydrochloride, dextromethorphan hydrobromide; benzocaine, sodium naproxen, and nicotine.

Nutraceuticals and nutritional supplements may also be added to films. Among these are herbs and botanicals that include, but are not limited to capsicum, chamomile, cat's claw, echinacea, garlic, ginger, ginko, various ginseng, green tea, golden seal, kava kava, nettle, passion flower, saw palmetto, St. John's wort, and valerian. Also included are mineral supplements such as calcium, copper, iodine, iron, magnesium, manganese, molybdenum, phosphorous, selenium and zinc. Other nutraceuticals that also can be added to film as active agents are benzoin, fructo-oligosaccharides, glucosamine, grapeseed extract, guarana, inulin, phosphotidylserine, phytosterols, phytochemicals, isoflavones, lecithin, lycopene, oligofructose, polyphenol and psyllium as well as weight loss agents such as chromium picolinate and phenylpropanolamine.

In some preferred embodiments of the present invention, the film comprises at least one antimicrobial agent. The film composition may include an orally active metallic ion as an antimicrobial agent, particularly salts of zinc, tin and silver and copper.

Other antimicrobial agents include the water insoluble non-cationic antimicrobial agents such as halogenated diphenyl ethers, phenolic compounds including phenol and its homologs, mono and poly-alkyl and aromatic halophenols, resorcinol and its derivatives, bisphenolic compounds and halogenated salicylanilides, benzoic esters, and halogenated carbanilides. The water soluble antimicrobials include quaternary ammonium salts and bis-biquanide salts, among others. Triclosan monophosphate is an additional water soluble antimicrobial agent. The quaternary ammonium agents include those in which one or two of the substitutes on the quaternary nitrogen has a carbon chain length (typically alkyl group) from about 8 to about 20, typically from about 10 to about 18 carbon atoms while the remaining substitutes (typically alkyl or benzyl group) have a lower number of carbon atoms, such as from about 1 to about 7 carbon atoms, typically methyl or ethyl groups. Dodecyl trimethyl ammonium bromide, tetradecylpyridinium chloride, domiphen bromide, N-tetradecyl-4-ethyl pyridinium chloride, dodecyl dimethyl (2-phenoxyethyl)ammonium bromide, benzyl dimethylstearyl ammonium chloride, cetyl pyridinium chloride, cetyl pyridinium saccharinate, quaternized 5-amino-1,3-bis(2-ethyl-hexyl)-5-methyl hexa hydropyrimidine, benzalkonium chloride, benzethonium chloride and methyl benzethonium chloride are exemplary of typical quaternary ammonium antibacterial agents. Other compounds are bis[4-(R-amino)-1-pyridinium]alkanes as disclosed in U.S. Pat. No. 4,206,215, issued Jun. 3, 1980, to Bailey, incorporated herein by reference. Other antimicrobials such as copper bisglycinate, copper glysinate, zinc citrate, zinc citrate-maleate, zinc lactate, hexetidine, hexamadine, furanones, and phalimido-peroxycaproic acid may also be included. Also useful are enzymes, including endoglycosidase, papain, dextranase, mutanase, and mixtures thereof. Such agents are disclosed in U.S. Pat. No. 2,946,725, Jul. 26, 1960, to Norris et al. and in U.S. Pat. 4,051,234, Sep. 27, 1977 to Gieske et al., incorporated herein by reference. Specific antimicrobial agents include chlorhexidine, triclosan and its derivatives including triclosan monophosphate, triclosan diphosphate, and phenolated triclosan and flavor oils such as thymol, geraniol, eugenol, and biosol. Triclosan and other agents of this type are disclosed in Parran, Jr. et al., U.S. Pat. No. 5,015,466, issued May 14, 1991, and U.S. Pat. No. 4,894,220, Jan. 16, 1990 to Nabi et al., incorporated herein by reference. These agents may be present at levels of from about 0.01% to about 10%, preferably from about 0.05% to about 5%, and more preferably from about 0.1% to about 2%, by weight of the film composition.

In some embodiments, the film may comprise agents that are effective in reducing calcium phosphate mineral deposition related to calculus formation. Pyrophosphate salts may be used in the present invention as anticalculus agents or as buffering agents, as long of the surface conditioning effects of the polymeric surface active agent is not eliminated.

The amount of pyrophosphate salt useful in making these compositions is any tartar control effective amount, and is generally from about 1.5% to about 15%, preferably from about 2% to about 10%, and most preferably from about 2.5% to about 8%, by weight of the film composition. Other agents included are synthetic anionic polymers [including polyacrylates and copolymers of maleic anhydride or acid and methyl vinyl ether (e.g., Gantrez), as described, for example, in U.S. Pat. No. 4,627,977, to Gaffar et al., the disclosure of which is incorporated herein by reference in its entirety; as well as, e.g., polyamino propoane sulfonic acid (AMPS)], zinc citrate trihydrate, diphosphonates (e.g., EHDP; AHP), polypeptides (such as polyaspartic and polyglutamic acids), and mixtures thereof.

In some embodiments, the film may comprise buffering agents to adjust the pH of the film and may help to stabilize the polymeric surface active agent. Other potential ingredients include a fluoride ion source. An alkali metal bicarbonate salt, surfactants, whitening agents such as peroxide or percarbonate, coloring agents, xylitol, thickening materials, binders, humectants, absorbents such as activated carbon, silica absorbents, cyclodextrins, and zeolites and combinations thereof, may also be included in the film composition.

A combination of medicament actives may be used in the film for various reasons. In some cases, medicaments may be reactive to one another and should be kept from coming in contact with each other. In other cases, combinations of medicaments may be used for various symptoms where multiple medicaments may be effective. For example, a decongestant such as pseudoephedrine may be added to one section of the film and and an antihistamine such as chloropheniramine may be added to a different section of the film to treat cold/allergy symptoms. For sore throat, an oral anesthetic like dyclonine hydrochloride may be used in one half of the film and an antibacterial agent like cetyl pyridinium chloride may be added to the other half of the film. Other combinations of medicament active agents for other types of ailments are also within the scope of this invention.

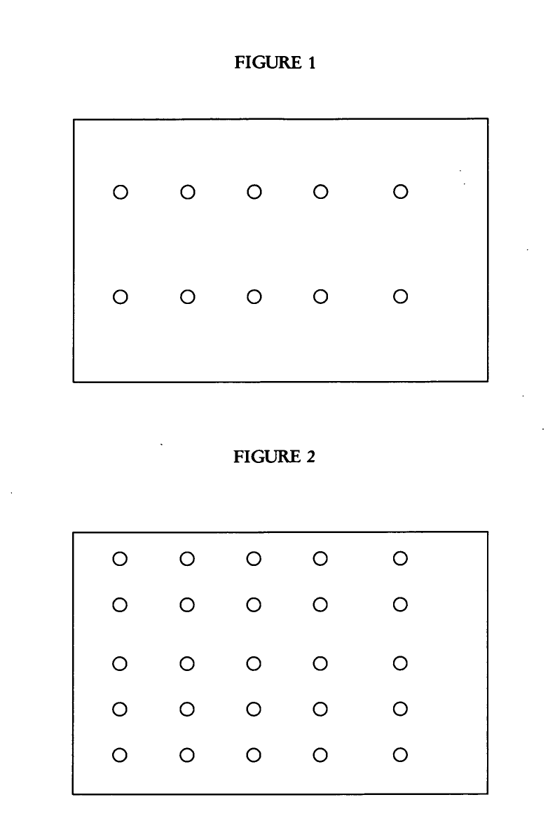

In accordance with the preferred embodiments of the present invention, the substances or agents are applied to the film in a predetermined pattern. The amount of extract and the pattern employed can be varied to provide the desired level of sweetness or provide a localized, high concentration of substance or drug. Common application patterns are shown in FIGS. 1-3. The amount applied can be varied to adjust for/accommodate the desired level of sweeting, substance or drug dose, or substance or drug diffusion properties. The patterning is not critical to the functioning of the present invention although the patterns shown herein are preferred embodiments.

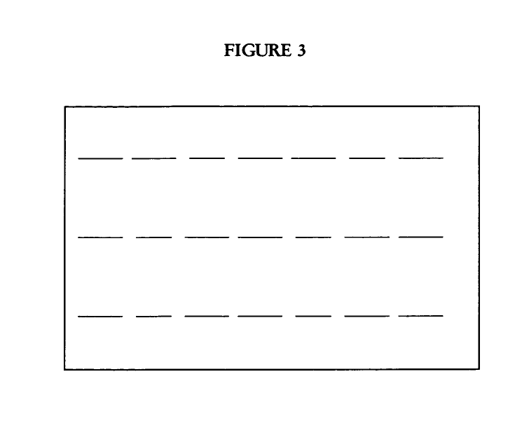

By way of example, FIG. 1 represent a typical pattern/amount to be applied for low levels of sweeting. By way of example, FIGS. 2-3 represent typical amounts of extract to be added for increasing the desired sweetness obtained. The extract can be added in any pattern including spotting, striping (vertical and/or horizontal), coating, impregnation, or any similar application techniques.

Flavor agents that can be used to prepare the film of the present invention include those known to the skilled artisan, such as natural and artificial flavors. These flavorings may be chosen from synthetic flavor oils and flavoring aromatics, and/or oils, oleo resins and extracts derived from plants, leaves, flowers, fruits and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. These flavor agents can be used individually or in admixture. Commonly used flavors include mints such as peppermint, artificial vanilla, cinnamon derivatives, and various fruit flavors, whether employed individually or in admixture. Certain flavoring agents, such as cinnamon, nutmeg, and vanilla have the added benefit of enhancing the effect of certain sweetness causing agents. Also included in the term flavorant are sensates and coolants. Preferred coolants include MGA, Physcool, WS-3, WS-23, TK-10, and combinations thereof. Generally, any flavoring or food additive, such as those described in Chemicals Used in Food Processing, publication 1274 by the National Academy of Sciences, pages 63-258, may be used. The amount of flavoring agent employed is normally a matter of preference subject to such factors as flavor type, individual flavor, and strength desired. Generally the flavoring is incorporated in the film of the present invention in an amount ranging from about 2.0 to about 10% by weight and preferably about 5 to about 8% by weight. Because of the ability to localize the flavor agents to their situs of action on the tongue, significantly lower amounts of these expensive agents can be used than if they were dispersed in a liquid medium.

Additional sweeteners useful in the practice of the present invention include both natural and artificial sweeteners. Generally speaking, those sweeteners temporarily binding to the taste buds longest will show the greatest sweetness increase in the film delivery compared to delivery in a dissolved solution. Suitable sweetener include water soluble sweetening agents such as monosaccharides, disaccharides and polysaccharides such as xylose, ribose, glucose (dextrose), mannose, glatose, fructose (levulose), sucrose (sugar), maltose, water soluble artificial sweeteners such as the soluble saccharin salts, i.e., sodium or calcium saccharin salts, cyclamate salts dipeptide based sweeteners, such a L-aspartic acid derived sweeteners, such as L-aspartyl-L-phenylalaine methyl ester (aspartame). Natural compounds known for their intense sweetness, so called natural high intensity sweeteners such as fruit juice or fruit juice concentrate from fruit of the Cucurbitaceae family, preferably Luo Han Guo fruit (Siraitia grosvenorii of the family Cucurbitaceae), serendipity berry (dioscoreophyllum cuminsii), glycyrrhizin from licorice root, stevioside from a Paraguayan herb, and protein fractions isolated from Serendipity berries and dihydrochalcones can also be used. Yet other examples of the non-nutritive sweeteners found in exotic fruit are dulcin or 4-ethoxyphenylurea and monellin, a protein from the berry of the plant dioscoreophyllum cuminsii and thaumatin from the fruits of the plant Thaumatococus daniellii. and the mogroside IV, mogroside V, siamenoside I or mixtures thereof. Combinations of these and natural sweetening compositions comprising: (a) sweet juice derived from the botanical genus/species Siraitia grosvenorii, S. siamensis, S. silomaradjae, S. sikkimensis, S. africana, S. borneensis, S taiwaniana or mixtures thereof; and (b) sugar, wherein said sugar is selected fructose, sucrose, glucose or mixtures thereof, and wherein the ratio of the sweet juice to the sugar is from about 1:1 to about 1:5, as set forth in U.S. Pat. No. 5,433,965 to Fischer, et al. can also be utilized.

In general, the effective amount of sweetener is utilized to provide the level of sweetness desired for a particular composition, will vary with the sweetener selected as well as other flavoring agents. This amount will normally be about 0.005% to about 5% by weight of the composition. The preferred amounts are in the range of about 0.01% to 5% by weight of the composition. The most preferred amounts are in the range of about 0.01% to 2% by weight of the composition.

The compositions of the present invention can also contain coloring agents or colorants. The coloring agents are used in amounts effective to produce the desired color and include natural food colors and dyes suitable for food, drug and cosmetic applications. These colorants are known as FD&C dyes and lakes. Acceptable materials for the foregoing spectrum of use are preferably water-soluble, and include FD&C Blue No. 2, which is the disodium salt of 5,5-indigotindisulfonic acid. Similarly, the dye known as Green No. 3 comprises a 15 triphenylmethane dye and is the monosodium salt of 4-[4-N-ethyl-p-sulfobenzylamino)diphenyl-methylene]-[1-N-ethyl-N-sulfonium benzyl)-2,5-cyclo-hexadienimine]. A full recitation of all FD&C and D&C dyes and their corresponding chemical structures may be found in the Kirk-Othrner Encyclopedia of Chemical Technology, Volume 5, Pages 857-884, which text is accordingly incorporated herein by reference. Further, the film can also include colorants and pigments, such as titanium dioxide, as well as tanning or sun protection ingredients. Anti-oxidants can also be included in the film. Suitable anti-oxidants are butylated hydroxyanisole, butylated hydroxytoluene, propyl galate, ascorbic acid and tocopherols.

The present invention is illustrated by the following examples.

### EXAMPLE 1

Three fruits from the plant species Synsepalum dulcificum were pitted and the skin removed. The fruit pulp was pureed. Using a blunt ended toothpick, the pureed extract was spotted onto a film strip in the pattern shown in FIG. 1. The spotted film was allowed to air dry for 15 minutes at room temperature.

The prepared strip was applied to the tongue and allowed to dissolve. The test subject then drank unsweetened lemonade and rated the sweetness. The resulting sweetness was (in five tests) determined to be the equivalent of the same lemonade having one teaspoons of sugar added.

### EXAMPLE II

After pitting, skin removal, and pureeing the pulp of three fruits from the plant species Synsepalum dulcificum the extract is applied onto a film strip in the general pattern shown in FIG. 1, but with twice the number of spots per square inch as described in Example 1. The spotted film is allowed to air dry for 15 minutes at room temperature.

The prepared strip is then applied to the tongue and allowed to dissolve. Drinking unsweetened lemonade and rating the sweetness, the resulting sweetness was (in five tests) determined to be the equivalent of the same lemonade having three teaspoons of sugar added.

### EXAMPLE III

Three fruits from the plant species Synsepalum dulcificum were pitted and the skin removed. The hit pulp was pureed. Using a blunt ended toothpick, the pureed extract was spotted onto a film strip in the pattern shown in FIG. 1. The spotted film was allowed to air dry for 15 minutes at room temperature.

The prepared strip was applied to the tongue and allowed to dissolve. The test subject then drank sweetened coffee and rated the sweetness. The resulting sweetness was (in five tests) determined to be the equivalent of the same coffee having one teaspoon of sugar added.

### EXAMPLE IV

Three fruits from the plant species Synsepalum dulcificum were pitted and the skin removed. The fruit pulp was pureed. Using a blunt ended toothpick, the pureed extract was spotted onto a film strip in the pattern shown in FIG. 3. The spotted film was allowed to air dry for 15 minutes at room temperature.

The prepared strip was applied to the tongue and allowed to dissolve. The test subject then drank coffee (unsweetened) and rated the sweetness. The resulting sweetness was (in five tests) determined to be the equivalent of the same coffee having 2-3 teaspoons of sugar added.

### EXAMPLE V

After pitting, skin removal, and pureeing the pulp of three fruits from the plant species Synsepalum dulcificum, a small portion of the extract is applied uniformly onto a film strip. The film is allowed to air dry for 15 minutes at room temperature.

A composition comprising three parts of alcoholic liquor distilled from the fermented juice of the Agave tequilana plant mixed with one part lime juice is ingested, rating the composition for sweetness. In multiple tests, the sweetness was determined to be equivalent to the same composition identically made with the addition of two parts triple sec, a highly sweetened liquor.

The embodiments illustrated and discussed in his specification are intended only to teach those skilled in the art the best way known to the inventors to make and use the invention. Nothing in this specification should be considered as limiting the scope of the present invention. Modifications and variations of the above-described embodiments of the invention are possible without departing from the invention, as appreciated by those skilled in the art in light of the above teachings. It is therefore to be understood that, within the scope of the claims and their equivalents, the invention may be practiced otherwise than as specifically described, which merely illustrate preferred embodiments.

What is claimed is:

1. An article for delivering a sugar substitute directly to the tongue comprising a film of the extract from the fruit of species of Synsepalum applied in or on a generally plainer surface.

2. An orally consumable film composition for delivering a sugar substitute the composition comprising a homogeneous mixture of (1) a water soluble film and (2) extract from the fruit of species of the plant genus Synsepalum.

3. The film composition of claim 2 wherein said extract is the extract from the fruit of species of the plant species Synsepalum dulcificum.

4. The film composition of claim 2 wherein said film is comprised of a homogeneous mixture of (1) a water soluble, low viscosity hydroxyalkylmethyl cellulose, the viscosity being in the range of 1 to about 40 mPa·multidot·s as determined as a 2% by weight aqueous solution at 20° C. using a Ubbelohde tube viscometer, (2) a water dispersible pregelatized starch, and (3) a flavoring agent.

5. The film composition of claim 2 wherein the hydroxyalkyl methyl cellulose is hydroxypropyl methyl cellulose.

6. The film composition of claim 2 wherein the viscosity of the hydroxyalkyl methyl cellulose is in the range of about 3 to about 30 mPa·multidot·s.

7. The film composition of claim 2 wherein the hydroxyalkyl methyl cellulose is present at a concentration of about 10 to about 60% by weight.

8. The film composition of claim 2 wherein the starch is present in the film in an amount ranging from about 5 to about 50% by weight.

9. The film composition of claim 2 wherein the weight ratio of hydroxyalkyl methyl cellulose to starch is in the range of about 1:3 to about 4:1.

10. The film composition of claim 2 wherein the weight ratio of hydroxyalkyl methyl cellulose to starch is in the range of about 1:1.5 to about 2:5.1.

11. The film composition of claim 3 wherein said extract is present on the surface of the film as spots.

12. The film composition of claim 3 wherein said extract is present on the surface of the film as strips.

13. The orally consumable film of claim 2 wherein the dosage is metered by removing sections of the film to create holes in said film prior to application onto the tongue.

14. A method for delivering a sweetening agent to the oral cavity which comprises preparing an orally consumable film composition which is rapidly dissolvable in the oral cavity, the composition being comprised of (1) a homogeneous mixture of a water soluble, low viscosity hydroxyalkylmethyl cellulose, the viscosity being in the range of 1 to about 40 mPa·multidot·s as determined as a 2% by weight aqueous solution at 20.degree. C. using a Ubbelohole tube viscometer, (2) a water dispersible starch, and (3) a sweetening agent.

15. The method of claim 14 wherein the hydroxyalkyl methyl cellulose is hydroxypropyl methyl cellulose and said sweetening agent is an extract from the fruit of Synsepalum dulcificum.

16. The method of claim 15 wherein the viscosity of the hydroxyalkyl methyl cellulose is in the range of about 3 to about 30 mPa·multidot·s.

17. The method of claim 15 wherein the hydroxyalkyl methyl cellulose is present at a concentration of about 10 to about 60% by weight.

18. The method of claim 15 wherein the starch is present in the film in an amount ranging from about 5 to about 50% by weight.

19. The method of claim 15 wherein the weight ration of hydroxyalkyl methyl cellulose to starch is in the range of about 1:3 to about 4:1.

20. The method of claim 15 wherein the weight ratio of hydroxyalkyl methyl cellulose to starch is in the range of about 1:1.5 to abut 2:5.1.

21. A method for delivering a sweetening agent to the oral cavity which comprises putting an extract of Synsepalum dulcificum on a swab and swabbing a portion of the tongue.

22. A method of controlling obesity by providing a sweetening effect in a human's mouth lasting for a controlled time period of from about 10 minutes to about 3 hours depending upon the specific dosage administered, said sweetening effect being such that low-caloric value foodstuffs containing acids subsequently ingested by the human during said time period will taste satisfyingly sweet comprising administering to said human an extract of the fruit of the plant Synsepalum dulcificum in an orally consumable film by placing said film on the tongue.

23. A method of controlling obesity by providing a sweetening effect in a human's mouth lasting for a controlled time period of from about 10 minutes to about 3 hours depending upon the specific dosage administered, said sweetening effect being such that low-caloric value foodstuffs containing acids subsequently ingested by the human during said time period will taste satisfyingly sweet comprising administering to said human an article comprising an extract of the fruit of the plant Synsepalum dulcificum as a film on said article.

24. A method of controlling the amount of sweetness generated by acidic foods comprising changing the amount of extract of the fruit of the plant Synsepalum dulcificum contacting a tongue by providing said extract in or on a film selected from the group consisting of: differing amounts of surface spots on the film, differing numbers of films, differing numbers of holes in the film.

25. An article for delivering a composition interacting with the taste buds directly to the tongue comprising a film of said composition applied in or on a generally plainer surface.
